(19) United States
(12) Patent Application Publication
(10) Pub. No.: US 2004/0117219 A1
(43) Pub. Date: Jun. 17, 2004

(54) Facility reserving method, facility reserving system, reserving terminal unit installed on site, and reservation program

(75) Inventors: Toyokazu Sugimoto, Tokyo (JP); Minoru Ashizawa, Tokyo (JP); Takuya Nagai, Tokyo (JP); Atsushi Ito, Tokyo (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD

(21) Appl. No.: 10/719,365

(22) Filed: Nov. 20, 2003

(30) Foreign Application Priority Data
Nov. 22, 2002 (JP) 2002-340029

(51) Int. Cl. G06F 17/60

(52) U.S. Cl. 705/5

(57) ABSTRACT

The invention aims to realize a sophisticated facility reserving service by handling paper admission tickets as electronic tickets and completely eliminating conventional restrictions in reservation. By mounting, by embedding, an information storage element such as an RF-ID tag in admission tickets 10 and by a center server 31 carrying out individual ID (identifier) management of the admission tickets 10, an advance and same-day facility reserving service by use of admission tickets is provided. For an advance reservation, by setting of information for a plurality of facilities and time slot thereof for a scheduled day of admission by use of communications infrastructures such as the Internet and Web access or via an operator such as a call center, and for a same-day reservation, by an on-site-installed reservation terminal 44 installed in an arbitrary location of the site, a facility reservation setting is carried out.

### BACKGROUND OF THE INVENTION

The present invention relates to a facility reserving method, a facility reserving system, a reservation terminal unit installed at a site, and a reservation program using admission tickets having electronic identifiers.

Conventionally, admission into sites of events such as concerts has been conducted by means of paper tickets. Sales or reservations of the admission tickets have been mainly carried out by entrustment to ticket sales agencies such as ticket agencies and convenience stores.

The same applies to amusement parks. In amusement parks, reservations for admission into attraction facilities scattered around the site have defined reserving methods, such as FASTPASS and UNIVERSAL EXPRESS, wherein a user inserts an admission ticket into a ticket dispenser near an attraction which he/she whishes to utilize on the-day of admission and receives a ticket. However, he/she cannot designate the time of admission (see Non-patent references 1 and 2).

On the other hand, with improvements in the Internet environment and progress in information storage techniques such as IC cards, it has become possible to carry computerized tickets.

A suggestion of storing computerized ticket information in an information storage chip excellent in security and using the same in substitution for a conventional paper ticket has been proposed. Recently, a low-profile flexible wireless tag (RF-ID) provided with an IC having a memory and a radio frequency circuit built-in has appeared, and an admission ticket has been proposed (see Patent reference 1) to adapt, for example, to credit cards, passports and admission tickets.

Non-patent Reference 1

“UNIVERSAL EXPRESS”

h**p://www.usj.co.jp/studioguide/attraction/efficient//index.html

Non-patent Reference 2

“FASTPASS”

h**p://www.tokyodisneyresort.co.jp/tdi/japanese/j#topics/index>fpass.html

Patent Reference 1

Japanese Unexamined Patent Publication No. Hei-8-88586 (Paragraph Number: 15, 40, FIG. 15)

However, according to the conventional facility reserving methods, designation of the time of admission is a designation by the promoter and is not a reflection of a user's intention. In addition, reservations are in all cases made on a first-come-first-served basis on the day, and there have been restrictions, for example, the user can make a reservation after utilizing a facility reserved earlier or after the elapse of a fixed time (only one facility per user).

### SUMMARY OF THE INVENTION

The present invention has been made in view of the above-described restrictions and background techniques, and it is an object of the present invention to provide a facility reserving method, a facility reserving system, a reservation terminal unit installed at a site, and a reservation program, which eliminate the above-described restrictions by handling admission tickets made of paper as electronic tickets and carrying out individual ID management of admission tickets and thereby realize a facility reserving service. In addition, it is an object of the present invention to provide a facility reserving method, a facility reserving system, an on-site-installed reservation terminal unit, and a reservation program, which are carried out by using admission tickets having identifies, which are convenient for those making reservations and those receiving reservations.

In order to solve the above-described problems, according to the present invention, an information storage element such as an RF-ID (Radio Frequency Identification) tag is mounted in an admission ticket by, for example, embedding, and a facility reserving system carries out individual ID (identifier) management of the admission tickets, whereby advance and same-day facility reserving service using admission tickets is provided. For an advance reservation, by setting information for a plurality of facilities and time slots thereof for a scheduled day of admission by use of communications infrastructures such as the Internet and Web access or via an operator such as a call center, and for a same-day reservation, via an on-site-installed reservation terminal installed in an arbitrary location of the site, facility reservation setting is carried out.

Thereby, paper admission tickets can be handled as electronic tickets.

As described in the above, according to the present invention, paper admission tickets can be handled as electronic admission tickets, conventional restrictions such that reservations are in all cases made on a first-come-first-served basis on the day, and where facility reservation is only for one facility per person are completely eliminated, and a sophisticated facility reserving service by use of admission tickets can be realized. Moreover, by use of an admission ticket provided with a first identifier by an information storing element and a second identifier by print (display), a service convenient not only for a person who makes a reservation and but also for a person who receives a reservation can be provided.

### DESCRIPTION OF THE DRAWINGS

FIG. 1 is a view cited for explaining a communications infrastructure used by a facility reserving system of an embodiment according to the present invention;

FIG. 2 is a view cited for explaining a relationship between a business model to realize an admission managing method and a facility reservation confirming method by admission tickets and main users thereof;

FIG. 3 is a block diagram showing by function development an internal construction of a center server mounted with a facility reserving system of an embodiment according to the present invention;

FIGS. 4A and 4B are views showing a data structure of an admission ticket ID-DB and an ID management DB used in an embodiment according to the present invention;

FIG. 5 is a view showing a data structure of a facility reservation DB used in an embodiment according to the present invention;

FIG. 6 is a block diagram showing by function development an internal construction of an on-site reservation terminal unit of an embodiment according to the present invention;

FIGS. 7A and 7B are flowcharts cited for explaining operations in an embodiment according to the present invention;

FIGS. 8A and 8B are flowcharts cited for explaining operations in an embodiment according to the present invention;

FIGS. 9A and 9B are flowcharts cited for explaining operations in an embodiment according to the present invention;

FIG. 10 is a flowchart showing processing procedures for a facility reservation program of an embodiment according to the present invention;

FIG. 11 is a view showing an example of a reservation screen composition used in an embodiment according to the present invention;

FIG. 12 is a view showing another example of a reservation screen composition used in an embodiment according to the present invention;

FIG. 13 is a view showing an external appearance of an admission ticket used in an embodiment according to the present invention;

FIG. 14 is a block diagram showing an internal construction of an RF-ID tag mounted by embedding in an admission ticket under an embodiment according to the present invention; and

FIG. 15 is a reference view showing a connection relationship of servers, etc.

### INCORPORATION BY REFERENCE

The present application claims priority to Japanese Patent Applications No.2002-340029, the contents of which are hereby incorporated by reference.

### DESCRIPTION OF THE PREFERRED EMBODIMENTS

Hereinafter, an embodiment of a facility reserving method, a facility reserving system, an on-site-installed reservation terminal unit, and a reservation program according to the present invention will be described in detail. In the present embodiment, paper admission tickets are handled as electronic tickets, and based on the admission tickets, an advance reservation of facilities is carried out by use of a communications infrastructure such as the Internet, or a gate pass on the day at the site, a facility reservation on the day at the site, agate pass at a facility, etc., are included as basic services. Moreover, various services such as an attend service wherein the contents of service are changed according to personal information, operations support such as a visitor flow line and residence-time analysis, and marketing such as facility utilization statistics are provided. Hereinafter, details thereof will be described.

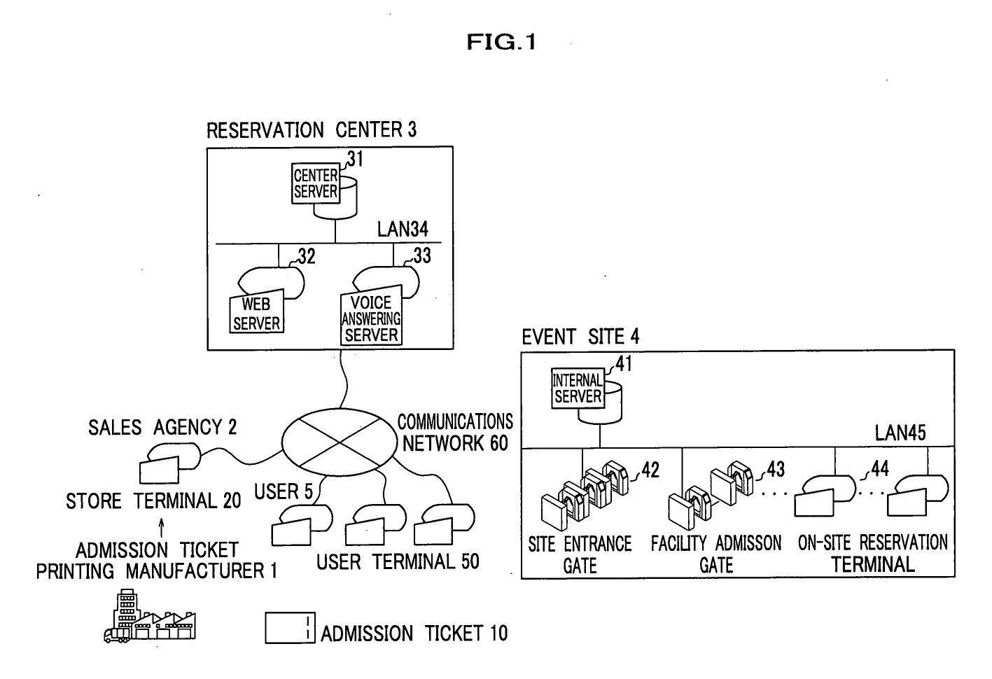

In FIG. 1, symbol 1 denotes an admission ticket printing manufacturer, and admission tickets herein printed and manufactured are delivered to sales agencies 2 such as ticket agencies and convenience stores 2 under the control of an event promoter (unillustrated).

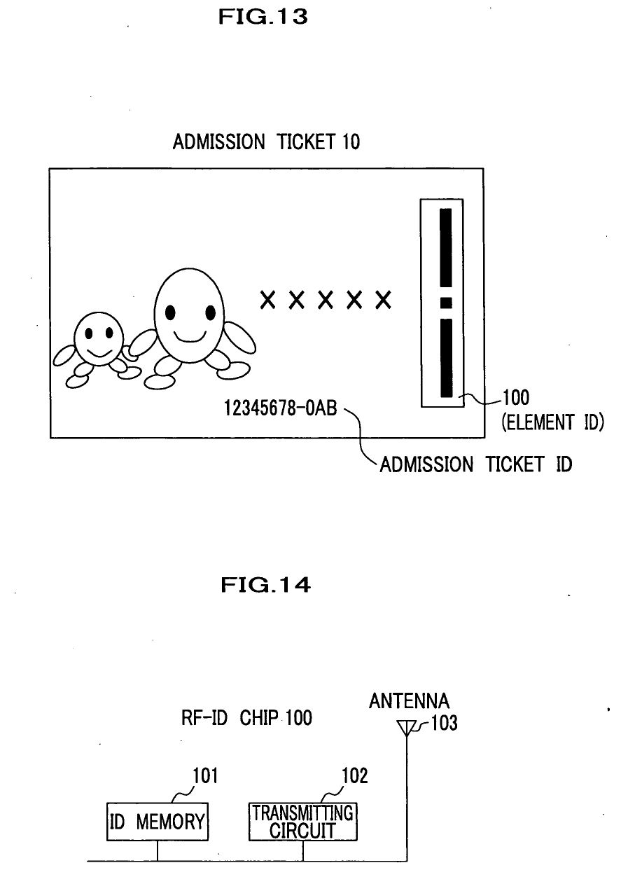

An admission ticket 10 is, as shown in FIG. 13, a slip of paper on which a human-perceptible admission ticket ID, herein, “12345678-0AB” has been printed (displayed) (incidentally, “0AB”is an additional code). The admission ticket 10 is, furthermore, embedded and mounted with an RF-ID tag (chip) 100, which is a non-contact information storage element having an element ID which is not recognizable to humans but is recognizable to computers. The admission ticket printing manufacturer 1 prints (displays) event-specific logos, characters, etc., including an admission ticket ID on blank slips of paper embedded and mounted with the RF-ID tag 100 and distributes these to the sales agencies 2. Then, a table of correspondence between the admission ticket IDs of the distributed admission tickets and element IDs of the RF-ID tags 100 is formed. Herein, the element ID corresponds to a “unique, first identifier,” and the admission ticket ID corresponds to a “unique, second identifier.”

Moreover,as shown in FIG.14, the RF-ID tag 100 is, for example, a semiconductor circuit comprising an ID memory 101 composed of a 128-bit ROM and a wireless transmission circuit 102, which can wirelessly communicate with the out side via anantenna 103. Herein, non-rewritable “μ-chip (R)” under development by the present applicant is used.

Details such as “μ-chip (R)” specifications have been disclosed in Nikkei Electronics 2002, Vol.2-25, pp.115. By use of the “μ-chip (R),” a unique identification number recorded in the ID memory 101 can be wirelessly readout from the out side without a battery.

The sales agency 2 not only sells an admission ticket to a user 5 as an entering visitor but also controls the state of sale by use of a store terminal 20.

In detail, at the sales agency 2, the element ID (first identifier) of the RF-ID tag 100 mounted by embedding in an admission ticket is read out, and this is notified to the reservation center 3 via a communications network 60, whereby status control thereof is carried out. In the reservation center 3, by adding, to a table of correspondence between the admission ticket IDs (second identifiers) printed (displayed) on admission tickets, which are manufactured by the admission ticket manufacturer 1, and the element IDs (first identifiers) of the RF-ID tags 100 mounted by embedding in the admission tickets, status information indicating whether or not the admission ticket 10 has already been sold, the state of sale of the tickets is controlled.

However, control of the sales status at the sales agency 2 is not essential for carrying out the present embodiment. By control of the sales status at the sales agency 2, when a reservation or admission into the site (facility) is intended to be made by use of an admission ticket which has not been sold, this can be rejected as fraudulent.

In addition to facility reservation, the reservation center 3 carries out, based on the admission ticket 10 sold to the user 5, control of entrance and exit at the event site entrance gate 42 and at each facility admission gate 43 of the site 4 and control of entrance and exit at restaurants, etc., of the site. For the control of entrance and exit, in addition to automatic gate control carried out by an entering/exiting visitor making his/her admission ticket be read by each gate, a response by an attendant carrying a portable card reader can be considered.

In addition, in the reservation center 3, a Web server 32 and a voice answering server 33 are installed with the center server 31 as a nucleus, and these are commonly connected through a LAN (Local Area Network) 34.

The center server 31 is mounted with a facility reserving system of the present embodiment and thus has a function to authenticate, by, for example, receiving an admission ticket ID printed on the admission ticket 10, the validity thereof and, after authentication, to carry out communications with a user terminal 50 connected via the communications network 60, and to register (a function for registering with a facility reservation DB 303) the element ID (element ID held by the center server 31) of the RF-ID tag 100 mounted by embedding in the admission ticket 10 and information for reserving facility names of the event site 4 and reservation time slots thereof produced by an operation of the user terminal 50 by the user 5 in an associated manner for reservation. Herein, authentication may be carried out after an input of the reserving facility names. Moreover, a facility name can be a facility code corresponding to the facility name.

The center server 31 simultaneously has a function to read out an element ID of the RF-ID tag 100 mounted by embedding in the admission ticket 10 via a site entrance gate 42 or a facility admission gate 43 when the user 5 to be an entering visitor enters the event site 4 or a facility of the event site 4 (or a read-out by an attendant carrying a portable admission administrative reader) and permit admission while referring to already-registered information (an ID management DB 302 and facility reservation information (a facility reservation DB 303) with the same element ID as a key.

Moreover, this function may also be provided for the side of the gates 42 and 43 so that, by being executed by internal server 41, the load of the center server 31 is reduced and a judgement as to admittance at the gates 42 and 43 can swiftly be carried out.

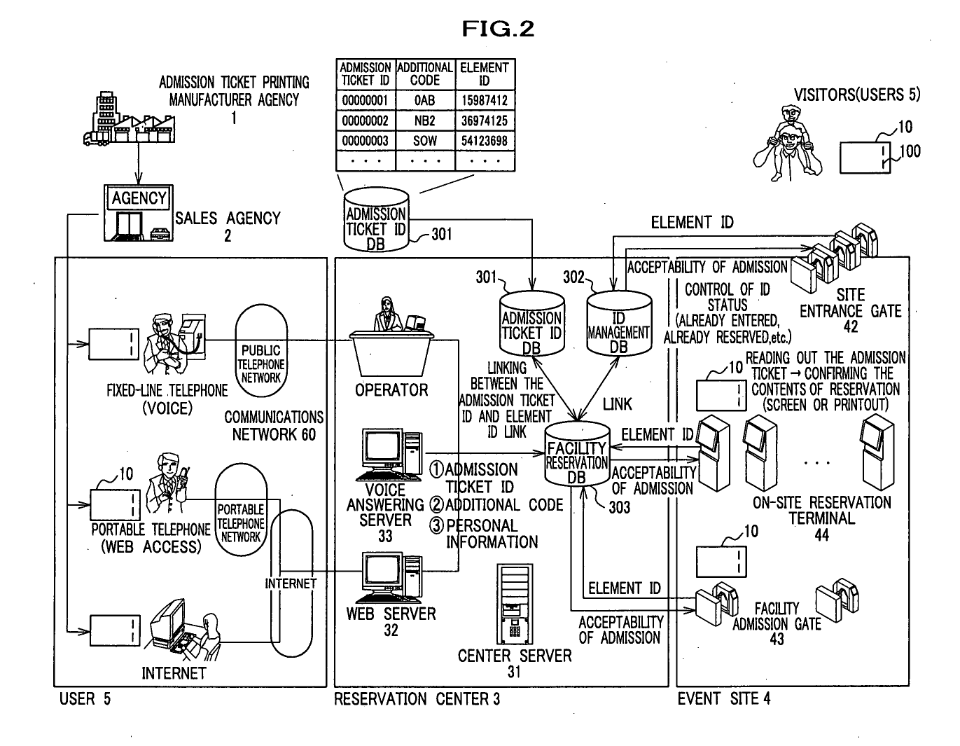

The Web server 32 takes charge of an interface with the user terminal 50 such as a personal computer or a portable telephone with a built-in browser connected by the IP (Internet Protocol) via the communications network 60, and the voice answering server 33 has a role of a call center by a voice call with a telephone terminal (a fixed-line telephone or portable telephone) connected via the communications network 60 (a reservation can also be made by a voice call with an operator, as shown in FIG. 2, which will be described later). Namely, in addition to a method via the Internet, the user 5 can reserve an on-site facility by a call and a push button operation, etc., with a telephone (that is, a reservation prompted by a screen display or a reservation prompted by a voice guide becomes possible.) Herein, a user in terms of a reservation includes not only a person him/herself who enters the event site by use of the admission ticket but also an agent who makes a reservation upon request and a person who makes a reservation as a gift or the like to another person.

At the event site 4, with the internal server 41 as a nucleus, a site entrance gate 42, a plurality of facility admission gates 43, multiple on-site reservation terminal units (on-site-installed reservation terminals) 44 scattered around the site are installed in a manner commonly connected to a LAN 45. The internal server 41 and the site entrance gate 42 compose a site entrance control unit, and the internal server 41 and the facility admission gate 43 compose a facility admission gate control unit.

The site entrance gate 42 and facility admission gate 43 are both controlled as to their gate ON/OFF by the internal server 41, and the on-site reservation terminal units 44 are used by the users 5 not only for a facility guide but also for a facility reservation on the day of admission.

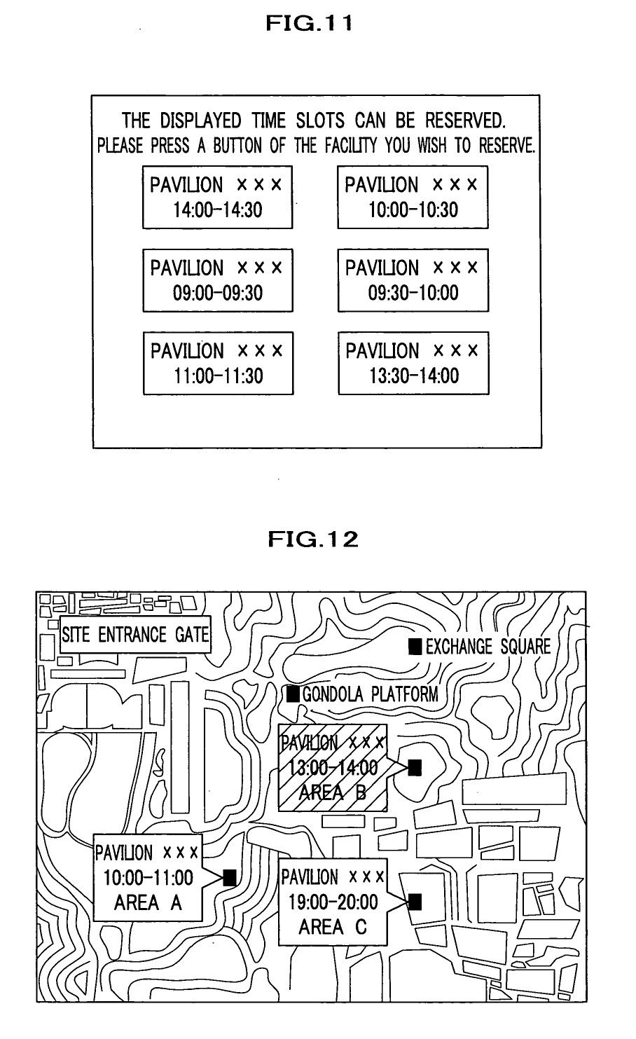

A facility reservation is carried out via a reservation screen, and examples of the facility reservation screen displayed on the on-site reservation terminal unit 44 are shown in FIG. 11 and FIG. 12. In addition, as described above, a facility reservation can also be carried out by voice or push button operation.

On the reservation screen shown in FIG. 11, reservation-available facilities are indicated by a button form along with time slot information, and a reservation is set by selecting and clicking a button (A). In addition, on the reservation screen shown in FIG. 12, reservation available facilities are displayed in a manner superimposed with a map, and already-reserved facilities and not-yet-reserved facilities are displayed with their balloon frames differentiated by colors, etc., and a reservation is set by touching a balloon frame. In the latter case, since on-site facilities and state of acceptability thereof are visually expressed in an associated manner, operationality at the time of reservation setting is improved. Details of both cases will be described later.

FIG. 2 is a view cited for explaining a relationship between a business model to realize an admission managing method and a facility reservation confirming method by use of admission tickets 10 and main users thereof. Herein, identical symbols will be used for components identical to those of FIG. 1 and description will thereby be omitted.

First, an admission ticket printing manufacturer 1 prepares a table of correspondence between admission ticket IDs printed on admission tickets 10 and element IDs of RF-ID tags 100 mounted by embedding in the admission tickets 10 to establish an admission ticket ID-DB 301. Next, a user 5 purchases admission ticket(s) 10 from, for example, a sales agency 2 and, directly or after an operation for a facility reservation, which will be described later, goes to an event site 4 to obtain admission. Herein, for the purchase of an admission ticket 10, similar to the conventions, the user 5 accesses the sales agency 2 via the telephone, the Internet, or Web and completes purchase of the admission ticket 10 itself. The user 5 indicates a claim number issued at this time or a user ID at the sales agency 2 such as a ticket counter or a convenience store, and after a collection of a charge or after a confirmation of payment completion by a bank-remittance of a charge, the admission ticket 10 is delivered (distributed) to the user 5 by post, for example. As a matter of course, the user 5 can directly purchase admission ticket(s) by visiting the sales agency 2.

The user 5 who has obtained the admission ticket 10 can enter the event site 4, even without a reservation, by carrying the admission ticket 10 with him/her and can also utilize the facilities. However, without a reservation for admission into a facility of the event site 4, he/she must stand in line to wait for his/her turn of admission if the facility is popular.

Herein, for admission into the event site 4, by bringing the admission ticket 10 close to a site entrance gate 42 or loading the same with the admission ticket 10, the site entrance gate 42 reads out the element ID of the RF-ID tag 100 embedded in the admission ticket 10 and judges as to admittance.

On the other hand, the user 5 who has obtained the admission ticket 10 can go to the event site 4 after reserving facilities of the event site 4 (after purchasing (by purchasing) an admission ticket 10 mounted with and displaying different IDs for a computer and a human, facilities can be reserved). As shown in FIG. 2, reservation can be carried out by means of a fixed-line telephone, a portable telephone, a personal computer, etc. This point will be described later in detail.

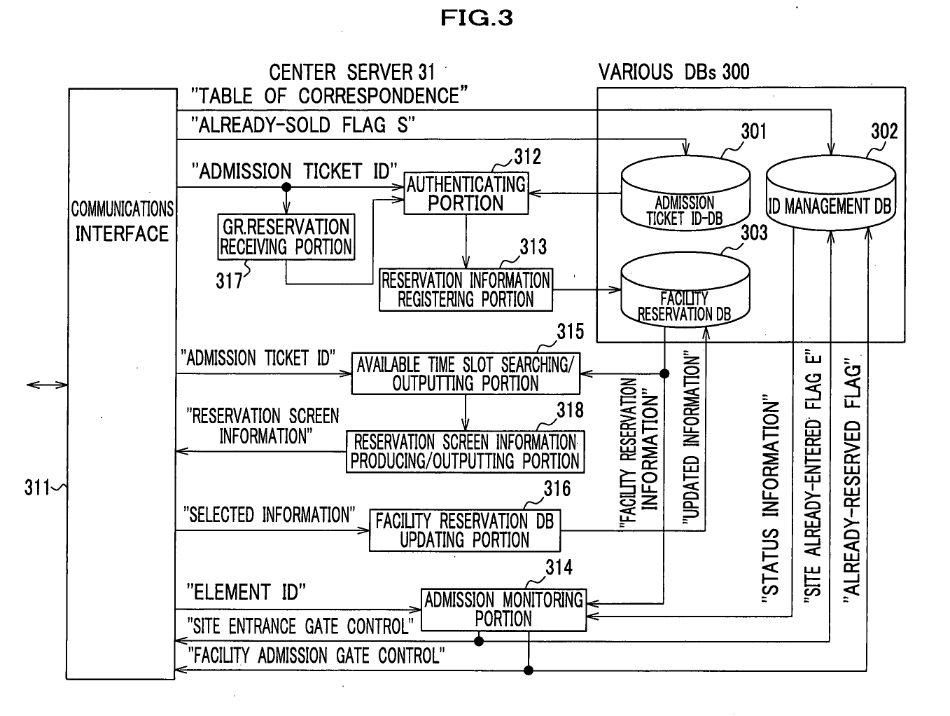

FIG. 3 is a block diagram showing by function development an internal construction of a center server 31 mounted with a facility reserving system of the present embodiment.

As shown in FIG. 3, the center server 31 comprises a communications interface 311, an authenticating portion 312, a reservation information registering portion 313, an admission monitoring portion 314, an available time slot searching/outputting portion 315, a facility reservation DB updating portion 316, a group (Gr.) reservation receiving portion 317, a reservation screen information producing/outputting portion 318, and various DBs 300. Herein, in a case where an internal server 41 judges as to admittance, the admission monitoring portion 314 is mounted in the internal server 41. In this case, the same applies to an ID management DB 302, which will be described later as one of the various DBs 300.

The communications interface 311 takes charge of an interface with a store terminal 20 of the sales agency 2, the internal server 41 of the event site 4, and a user terminal 50 of the user 5, and herein, since these are all connected via a communications network over the Internet or a LAN, a TCP/IP (Transmission Control Protocol/Internet Protocol) is mounted.

Moreover, the authenticating portion (authenticating means) 312 has a function to, by receiving a unique admission ticket ID printed (displayed) on the admission ticket 10, the validity thereof. The reservation information registering portion 313 has a function to receive an authentication by the authenticating portion 312, carry out communications with a user terminal 50, and register, with a facility reservation DB 303, a unique element ID of an information storage element mounted by embedding in the admission ticket 10 and information for reserving facility names and a reservation time slots thereof produced by an operation of the user terminal 50 by the user 5 in an associated manner. The facility reservation DB 303 registered as such is used for facility admission management (for example, a judgement as to admittance, a forecast of the number of visitors, etc.)

The admission monitoring portion 314 has a function to read out an element ID of the admission ticket 10 via the facility entrance gate 42 or facility admission gate 43 at the time of admission into a site or facility and permit or prohibit admission by a gate ON/OFF of the facility entrance gate 42 or facility admission gate 43 while referring to facility reservation information registered with the ID management DB 302 and facility reservation DB 303 with the same element ID as a key. As described above, this function may be separated from the center server 31 and be provided for the side of the gates 42 and 43 (internal server 41).

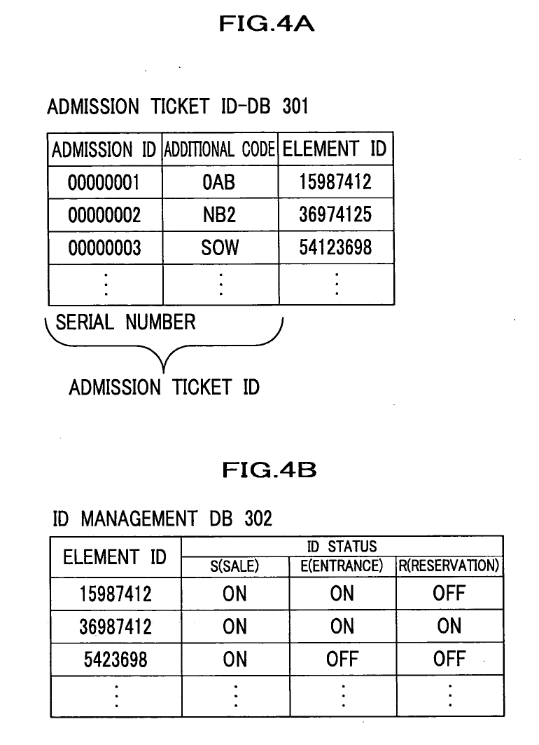

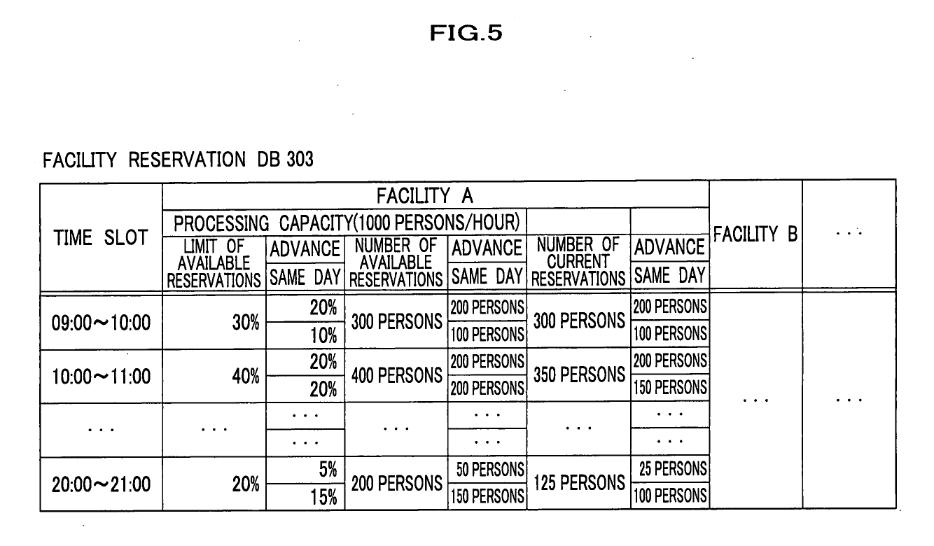

Moreover, the various DBs 300 include an admission ticket ID-DB 301, an ID management DB 302, and a facility reservation DB 303, and for the admission ticket ID-DB 301, a data structure example is shown in FIG. 4A, and for the ID management DB 302, in FIG. 4B, and for the facility reservation DB 303, in FIG. 5.

In FIG. 4A, the admission ticket ID-DB 301 is composed of respective fields of admission IDs (a serial number part of admission ticket IDs), additional codes (an additional part of admission ticket IDs), and element IDs.

The admission ticket IDs have a one-on-one corresponding relationship with the element IDs, and these are prepared based on the table of correspondence prepared when the admission ticket printing manufacturer 1 prints admission ticket IDs and contents of the events on the blank admission tickets 10 embedded and mounted with the RF-ID tags 100. In addition, the additional codes are codes containing three-digit alphabetic characters, for example, which are added as tampering protection, since the admission ticket IDs (serial number part) are rows of sequential numerals. As will be described later, by authenticating a correspondence between the admission ticket ID (serial number part) and additional code inputted when a reservation is made by utilizing the Internet, etc., a reservation by tampering or a fraudulent reservation by a user possessing no admission ticket 10 is prevented, for example.

In FIG. 4B, in the ID management DB 302, admittable element IDs or non-admittable element IDs are listed, and ID status information corresponding to each ID thereof is included. As the ID status information, the ID management DB 302 has three types of status of already-sold (S), already-entered (E), and already-reserved (R). Herein, S is set by the sales agency 2 (since the sales agency 2 is not essential, if no sales agency 2 exists, this type of status does not exist either), and E is set by the site entrance gate 42 or facility admission gate 43, and S is set by the center server 31 or an on-site reservation terminal unit 44.

In addition, for a list of non-admittable element IDs, element IDs of admission tickets once entered the site are made non-admittable. In addition, it is not essential that the ID management DB 302 solely exists, and it is also possible that the admission ticket ID-DB 301 is constructed with a status information field. In such a case, a copy thereof is provided in the internal server 41 of the event site 4 if necessary so that the site entrance gate 42, facility admission gate 43, and on-site reservation terminal units 44 can promptly access the same.

FIG. 5 is a view showing a part of the facility reservation DB 303, and this part is a data base wherein limits in the number of available reservations of a facility according to admission time slots are preset by an operator or the like and numbers of already-reserved visitors at the moment are stored one after another. In addition, the facility reservation DB 303 is also a data base wherein information for reserving facility names and reservation time slots thereof are stored (registered) in a manner associated with an element ID, although this is not shown in FIG. 5.

The facility reservation DB 303 (the part shown in FIG. 5) is composed of fields of capacity and number of reservations at the moment according to facilities installed at an event site and according to time slots. As the capacity, limits of available reservations (%) and numbers of available reservations (numbers of visitors) in advance and on the day are artificially set by, for example, an operator according to time slots.

Returning to the description of FIG. 3, the available time slot searching/outputting portion 315 has a function, for an advance reservation, to refer to the facility reservation DB 303 upon receiving an reservation input of a date and time of admission via the user terminal 50 and to search for and output available time slots of reserving facilities on the day of admission where the current number of already-reserved visitors<limit in the number of available reservations. In addition, for a same-day reservation, the available time slot searching/outputting portion 315 has a function to refer to the facility reservation DB 303 upon the user 5 making the admission ticket 10 be read into the on-site-installed reservation terminal unit 44 and to search for and output available time slots of an applicable reserving facility on the day of admission where the current number of already-reserved visitors<limit in the number of available reservations.

The facility reservation DB updating portion 316 has a function, for an advance reservation, to register, with the facility reservation DB 303, time slot information selected from available time slots by the user 5 in a manner associated with his/her element ID and to update the number of already-reserved visitors at the moment. In addition, for a same-day reservation, the facility reservation DB updating portion 316 simultaneously has a function to register, with the facility reservation DB 303, times lot information selected from available times lots in a manner associated with his/her element ID and to update the number of already-reserved visitors for the day at the moment.

On the other hand, the group reservation receiving portion 317 has a function to receive, via an admission ticket 10 possessed by a representative, unique admission ticket IDs printed on a predetermined number of admission tickets 10 and permit a reservation input thereof only for an identical time slot of an identical facility.

Moreover, the reservation screen information producing/outputting portion 318 has a function, by referring to the facility reservation DB 303 at the time of facility reservation, irrespective of in advance or on the day, to produce screen information in a form where information for reservation-available facility names and time slots thereof can be selected by the user 5 and to provide the same to the user terminal 50 or the on-site-installed reservation terminal 44.

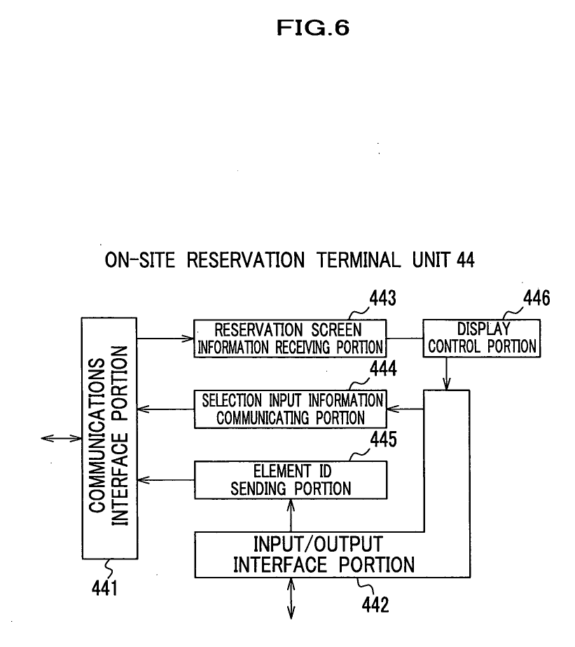

FIG. 6 is a block diagram showing by function development an internal construction of an on-site reservation terminal unit 44 installed at an event site.

The on-site reservation terminal units 44 are installed in a manner scattered around the event site 4, and each is provided with a liquid crystal touch panel as hardware and is, moreover, as a peripheral device, provided with a tag reader for wirelessly reading the element ID of the RF-ID tag 100 mounted by embedding in the admission ticket 10 (both are unillustrated).

The on-site reservation terminal unit 44 is composed of a communications interface 441, an input/output interface 442, a reservation screen information receiving portion 443, a selection input information communicating portion 444, an element ID sending portion 445, and a display control portion 446.

The communications interface 441 takes charge of an interface with the center server 31 while being relayed by the internal server 41 installed at the event site 4, and since this communications interface 441 is herein LAN-connected with the internal server 41, a TCP/IP is mounted. The input/output interface 442 takes charge of an interface with a liquid crystal touch panel or tag reader connected as a peripheral device so as to take in and display data inputted/outputted via the liquid crystal touch panel or supply an element ID read via the tag reader to the element ID sending portion 445.

The reservation screen information receiving portion 443 has a function to communicate with the center server 31 upon approximation or loading of the RF-ID tag 100 mounted by embedding in the admission ticket 10 and receive reservation screen information in a form where reservation-available facility names and time slots thereof can be selected via the communications interface 441 from the center server 31.

The selection input information communicating (sending) portion 444 has a function to take in a selection input for a facility reservation by a user while displaying, on the liquid crystal panel, reservation screen information received by the reservation screen information receiving portion 443 and send the same to the center server 31 via the communications interface 441, LAN 45, internal server 41, and communications network 60.

Moreover, the display control portion 446 has a function to enlarge the reservation screen information received at the reservation screen information receiving portion 443 and display, in addition to a present location, an arrangement of facilities installed at the periphery in a map form and also to produce display data to display already-reserved facilities in a manner differentiated from other facilities and display the same on the liquid crystal touch panel via the input/output interface 442.

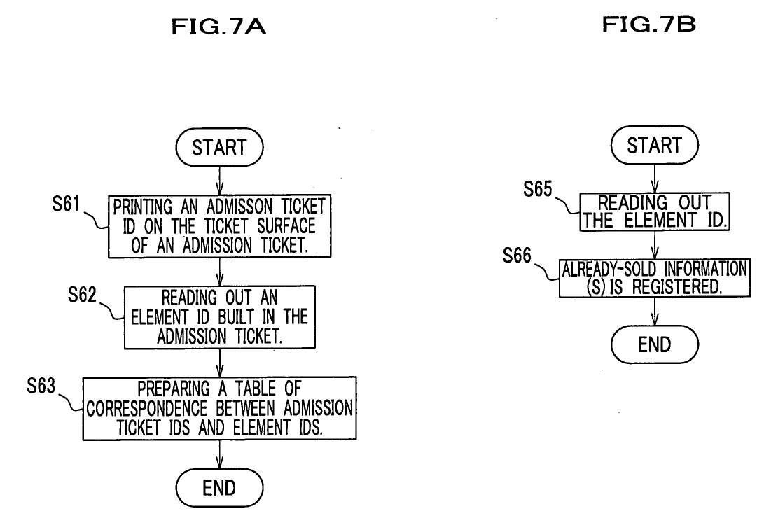

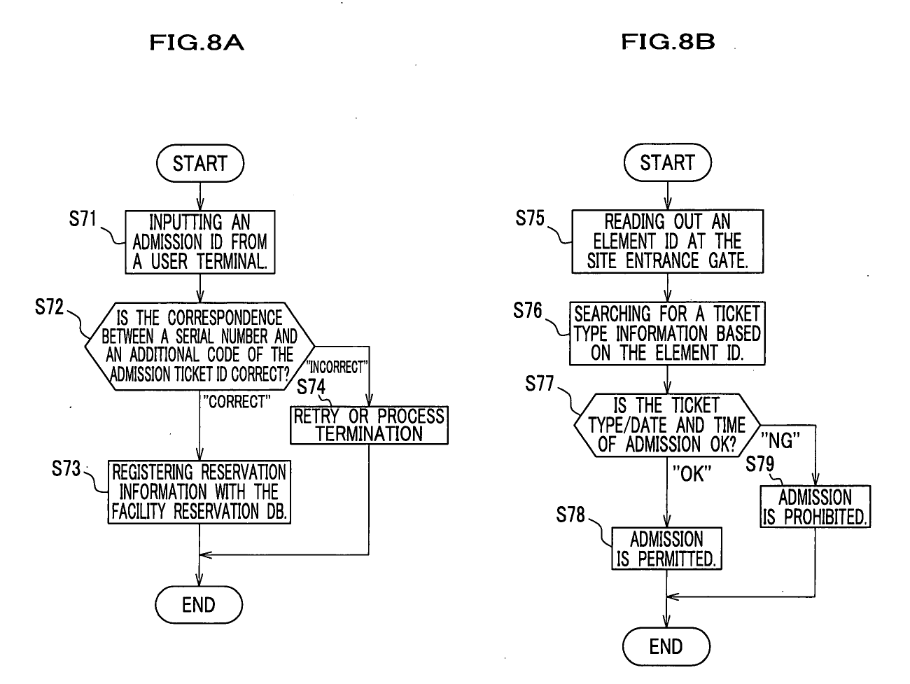

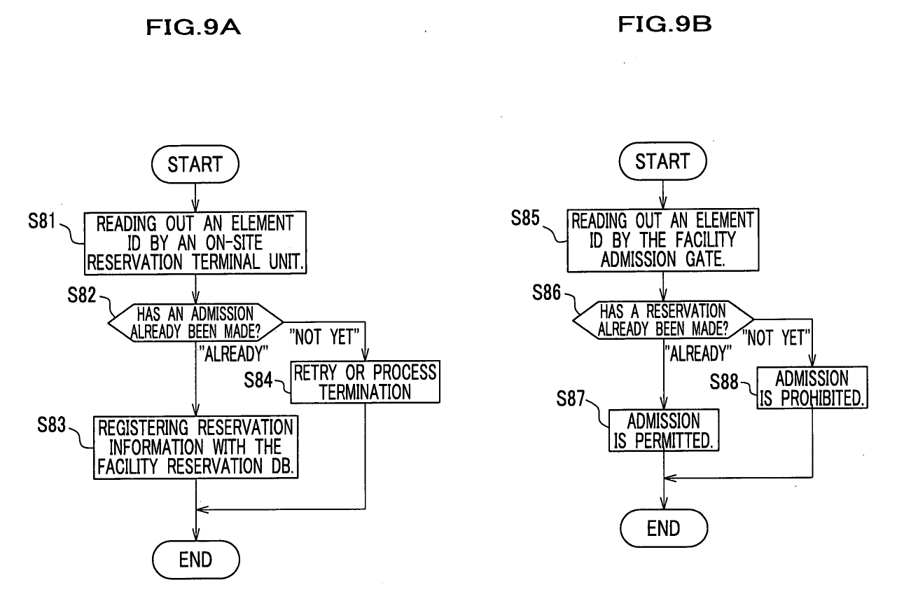

FIGS. 7 through FIGS. 9 are flowcharts cited for explaining operations of the present embodiment, which are shown as relates to the time of manufacturing admission tickets (FIG. 7A), sale of admission tickets (FIG. 7B), advance reservation for admission (FIG. 8A), admission (FIG. 8B), reservation at a site (FIG. 9A) and admission into a facility (FIG. 9B), respectively.

Hereinafter, operations of the present embodiment will be described with reference to the flowcharts shown in FIGS. 7 through FIGS. 9.

Operations at the time of manufacturing admission tickets will be described with reference to the flowchart shown in FIG. 7A.

The admission ticket printing manufacturer 1, first, prints information concerning an event including an admission ticket ID on the ticket face of a paper admission ticket embedded and mounted with an RF-ID tag 100 (S61). Although, as described above, the admission ticket ID to be printed (displayed) is composed of a serial number part and an additional code, an addition such as a ticket-type code (one-day ticket, half-day ticket, etc.) can also be considered.

Furthermore, the admission ticket printing manufacturer 1 reads out an element ID of the RF-ID tag 100 mounted by embedding in the admission ticket by means of a dedicated terminal (unillustrated) (S62), and prepares a table of correspondence between herein read element IDs and admission IDs (S63) and establishes an admission ticket ID-DB 301.

Operations of the store terminal 20 at the time of an admission ticket sale will be described with reference to the flowchart shown in FIG. 7B.

The sales agency 2 such as a ticket agency or a convenience store reads out, when selling admission ticket(s) to a user 5, an element ID of the RF-ID tag 100 embedded and mounted in the admission ticket 10 by means of a provided shop terminal 20 (S65). Herein, since the sales agency 2 is not essential, an element ID input at the time of sale may be omitted. Then, to an applicable element ID entry of the previously prepared admission ticket ID-DB 301, information of already-sold (S) is registered as status information (S66). The status information herein added is reflected not only in the admission ticket ID-DB 301 but also in the ID management DB 302.

Herein, the sales agency 2 sells admission tickets 10 on behalf of an event promoter, however, it can also be considered that, without selling admission tickets printed by the admission ticket printing maker 1, the sales agency 2 by itself prints the event information including an admission ticket ID on blank admission tickets embedded and mounted with an RF-ID tag 100 and sells the same. In this case, as a matter of course, an agreement with the event promoter is required as appropriate, and moreover, a dedicated terminal for that purpose is also prepared if necessary.

Operations of the center server at the time of advance reservation will be described with reference to the flowchart shown in FIG. 8A.

The user 5 inputs an admission ID printed on the purchased admission ticket 10 by operating the user terminal 50 such as a portable telephone terminal with a built-in browser or a personal commuter in his/her own house (S71). The reservation center 3 (Web server 32) carries out, to the user terminal 50, a screen display to prompt an admission ID input and receives (input) an inputted admission ticket ID. The center server 31 which has received the admission ticket ID over the communications network 60 and Web server 32 authenticates whether or not the correspondence between a serial number and an additional code of the admission ticket ID is correct (S72). Herein, when authentication is obtained, this reservation information is registered with a facility reservation DB 303 (S73).

Facility reservation information is registered, based on the information for reserving facilities and reservation time slots produced by browsing of a screen (a facility reservation screen) (which will be described later) and operating the user terminal 50 by the user 5, with an addition of an element ID corresponding to the authenticated admission ticket ID by the center server 31.

On the other hand, if authentication is not obtained, the authentication is retried or the process is terminated (S74).

Thereby, an advance reservation service by means of admission tickets 10 becomes possible, and by individual ID management of admission tickets, a sophisticated and convenient service can be provided for visitors. Moreover, at the time of reservation, if personal information is recorded, it is also possible to change the contents of service according to the personal information. In addition, a facility reserving system excellent in security while making use of the features of an RF-ID tag 100 such as being non-contact and difficult to counterfeit can be provided.

The above-described embodiment has been described in a case of an advance reservation over the Internet or Web, and in addition thereto, an advance reservation by voice or push button operation by use of a telephone terminal (a fixed-line telephone or the like) is also possible (a reservation by being prompted by a voice guide such as, “Please give your admission ticket ID.”) In this case, an operator on the register of the reservation center 3 responds therewith. Or, the voice answering server 33 responds therewith. As a matter of course, similar to a facility reservation by utilizing the Internet, facility reservation information is registered with the facility reservation DB 303.

Moreover, in an advance reservation, a reservation in a group, that is, a reservation of an identical facility and an identical time slot can be made by inputting the number of persons and admission ticket IDs for the same number of persons. In this case, an input of unique admission ticket IDs printed on the respective admission tickets for the predetermined number of persons is received, and a reservation input thereof only for an identical time slot of an identical facility is permitted.

With reference to the flowchart shown in FIG. 8B, operations of the center server 31 or the site entrance gate 42 will be described.

The user is, when entering the event site 4, permitted to enter the event site 4 by bringing the admission ticket close to the site entrance gate 42 or loading the same with the admission ticket. Herein, since the admission ticket 10 is embedded and mounted with the RF-ID tag 100, only bringing the admission ticket close is sufficient and loading is unnecessary. Namely, the element ID of the RF-ID tag 100 embedded and mounted in the admission ticket is read out (S75), and ticket type information is searched by referring to the admission ticket ID-DB 301 based on the read out element ID (S76). A search herein may be carried out by the server 31 of the reservation center 3 or may be locally processed at the event site 4. However, in the latter case, a copy of the admission ticket ID-DB 301 becomes necessary.

Herein, the admission ticket may be inserted into a card inserting slot (unillustrated) of the site entrance gate 42, and in this case, since admission ticket stamping such as print and punch holes can be visually checked by an attendant, an effect to prevent illegal resale of admission tickets for which an admittance has once been made is provided.

Herein, the date and time of admission is checked (S77), and the gate is controlled so that if it is matched with the date and time of admission, admission is permitted (S78), and if it is not matched, admission is prohibited (S79). Moreover, if ticket type information is included in the admission ticket, the ticket type is also checked in addition to the date and time of admission, and gate control is carried out in a similar manner to the date and time of admission. Ticket types can be classified into a one-day ticket/a half-day ticket, an adult ticket/a child ticket, etc., and although unillustrated, the ticket type is stored in the admission ticket ID-DB 301 in a manner corresponding with the admission ticket ID.

By thus introducing a non-contact RF-ID tag 100, a paper admission ticket 10 can be handled as an electronic ticket, and since admittance into the event site 4 is controlled by an association of the admission ticket ID printed on the ticket surface with the element ID unique to the RF-ID tag 100 and by current status of the element ID, a sophisticated and convenient service which enables a smooth gate pass (pass by touch and go) and is also excellent in security can be provided. Moreover, since the admission ticket is made of paper, load which can be exerted on the environment in disposal, etc., can be reduced.

Next, with reference to the flowchart shown in FIG. 9A, operations of the center server 31 or internal server 41 at the time of same-day reservation at the event site 4 will be described.

The user 5 brings the ticket 10 close to the on-site reservation terminal unit 44 or loads a reader part with the admission ticket 10 and thereby makes the element ID be read (S81). The element ID herein read is supplied to the internal server 41 or the center server 31 of the reservation center 3, and herein, flag information (E) of the ID management DB 302 is checked to examine whether or not an admission has already been made (S82).

When it is confirmed that an admission has already been made, based on facility name and time slot information inputted by the user 5 while browsing a reservation screen displayed on the liquid crystal touch panel of the on-site reserving terminal unit 44, facility reservation information is registered with the facility reservation DB 303 (S83), and when it is not confirmed, confirmation is retried or reservation becomes impossible and the process is terminated (S84).

By thus introducing the non-contact RF-ID tag 100, a paper admission ticket 10 can be handled as an electronic ticket, and since reservation acceptability on the day is controlled by an association of the admission ticket ID printed on the ticket surface with the admission ticket ID unique to the RF-ID tag 100 and by current status of the element ID, a sophisticated and convenient service which is also excellent in security can be provided. Moreover, compared to an electronic ticket made of plastic or the like, load which can be exerted on the environment when the admission ticket 10 is disposed can be reduced. In addition, at the time of same-day reservation, no manual input of the user is necessary, and it is sufficient to only read in the admission ticket and carry out a touch input for reservation setting while browsing the reservation screen, therefore, operationality can be greatly improved.

Moreover, if the admission ticket 10 is degraded and its element ID cannot be read in, after the admission ticket 10 is confirmed to be valid based on the admission ticket ID, the admission ticket 10 can be replaced by a new admission ticket at the event site 4. Accordingly, even if an unexpected situation where the admission ticket 10 cannot be used occurs, it can be recovered and convenience can be provided for the user 5. However, in this case, in terms of the system, it is necessary to update the contents of the admission ticket ID-DB 301, ID management DB 302, and facility reservation DB 303.

While referring to the flowchart shown in FIG. 9B, operations of the facility admission gate when the user 5 enters a facility will be described.

The user 5 brings, when entering a facility, the carrying admission ticket 10 close to the facility admission gate 43 or loading the same with the admission ticket. Herein, the element ID of the RF-ID tag 100 embedded and mounted in the admission ticket 10 is read out (S85). Then, based on the read out element ID, whether or not a reservation has already been made is checked by referring to the facility reservation DB 303 (S86). Herein, information for the reserved facility name and time slot thereof is examined, and gate ON/OFF of the facility admission gate 43 is controlled so that if matching is obtained, admission into the applicable facility is permitted (S87), and if no matching is obtained, admission is prohibited (S88).

If gate ON/OFF control is carried out by the internal server 41 at the event site, it is necessary to have a copy of the facility reservation DB 303, and if control is carried out by the center server 31, it is necessary to obtain a copy of facility reservation data corresponding to facility reservations for the day in advance.

Moreover, a check at the time of facility admission is not limited to its gate and can be replaced by a check by use of a handy reader carried by an attendant. For an entrance and exit check of a restaurant, application of the latter is realistic.

By thus introducing a non-contact RF- ID tag, a paper admission ticket 10 can be handled as an electronic ticket, and since admission into a facility is controlled by an association of the admission ticket ID printed on the ticket surface with the element ID unique to the RF-ID and by current status of the element ID, a sophisticated and convenient service which enables a smooth pass through the facility admission gate 43 and is also excellent in security can be provided by combination with personal information.

Moreover, by a combination with personal information, a wide variety of services such as an attend service wherein the contents of service are changed according to personal information, operations support such as a visitor flow line and residence-time analysis, and marketing such as facility utilization statistics are provided.

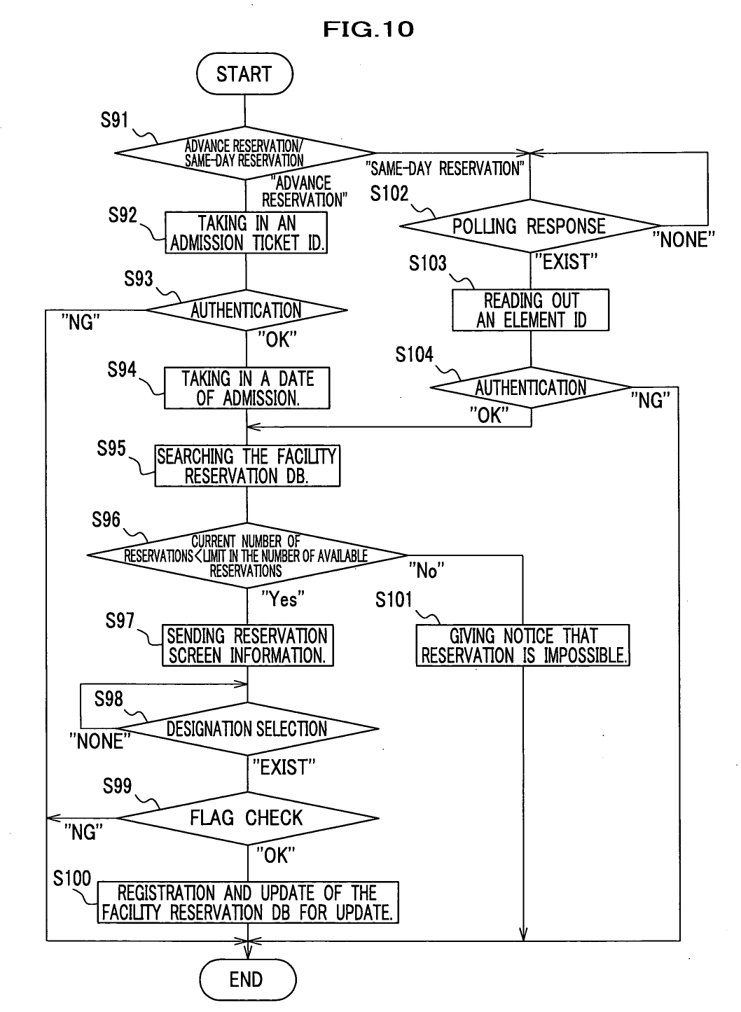

FIG. 10 is a flowchart showing processing procedures for a facility reservation program of the present embodiment. Hereinafter, with reference to this flowchart, operations of a facility reserving system (reserving method) of the present embodiment will be described in detail.

According to the facility reserving system of the present embodiment, both the advance reservation and same-day reservation are possible, and the former is carried out over the Internet or Web, and the latter is carried out via on-site reservation terminal units 44 installed in a scattered manner around the site 4. In either case, reservation information is set by the user inputting the names of preferred facilities and time slots while browsing a reservation screen displayed on the user terminal 50 or on-site reservation terminal unit 44. Herein, a description will be made while citing a function development diagram of a center server 31 shown in FIG. 3 and function development diagrams of an on-site reservation terminal unit 44 shown in FIG. 7.

First, in the case of an advance reservation (S91 “advance reservation”), the center server 31 takes in an admission ticket ID inputted by the user 5 over the communications network 60 (S92) At this time, on the user terminal 50, a screen to prompt an input of the admission ticket ID, such as “Please input your admission ticket ID,” is displayed. When the admission ticket ID is taken in (received), the reservation information registering portion 313 is started up through an authentication (S93) by the authenticating portion 312. As described above, authentication may be carried out later.

After authentication, the reservation information registering portion 313 takes in information for a preferred date of admission produced by the user 5 operating the user terminal 50 by being prompted by a screen display, such as “Please input your preferred date of admission” (S94), and searches facility reservation DB 303 (S95). As a result, the available time slot searching/outputting portion 315 searches for and outputs facility name(s) having available time slot(s) where “number of current reservations<number of available reservations” (S96), and based on the searched and outputted facility name(s), the reservation screen information producing/outputting portion 318 produces reservation screen information (screen information to prompt a facility selection) required for the user 5 to select the facilities and sends the same (S97). Herein, if no facility matches the above-described conditions, a notice that reservation is impossible is given (S101), and the process is terminated.

The user 5, who has browsed the reservation screen information by use of the user terminal 50, selects and designates a preferred facility (facility name) by being prompted by a screen display, such as “Please select a facility you wish to reserve.”

The center server 31, which has taken in a selection input over the communications network 60 (S98), checks the status information of the ID management DB to refer to an already-sold flag (S) (S99), and thereby confirms that the admission ticket 10 has been legally sold, separately from an authentication in step S93 and step S104 (confirmation is possible only when sales status control has been carried out). If the flag check results in OK, the facility reservation DB updating portion 316 registers information for the selected facility name and time slot with the facility reservation DB 303 for update. Simultaneously, the field of the number of current reservations of the facility reservation DB 303 is updated by +1 (S100). If the flag check results in NG, the process is terminated.

On the other hand, in the case of a same-day reservation (S91 “same-day reservation”), by bringing an admission ticket close to the on-site reservation terminal unit 44, a wireless polling response is received, and an element ID of the RF-ID tag 100 embedded and mounted in the admission ticket 10 can be read out (S103). The element ID is read out via the input/output interface 442 and is sent by the element ID sending portion 445 to the center server 31 via the communications interface 441. The center server 31, which has taken in the element ID, carries out authentication, and if authentication is obtained, processes from S95 onward are carried out, and if authentication is not obtained, the process is terminated.

If authentication is obtained, the available time slot searching/outputting portion 315 searches for and outputs facility name(s) having available time slot(s) where “number of current reservations<number of available reservations” (S96), and based on the searched and outputted facility name(s), the reservation screen information producing/outputting portion 318 produces reservation screen information required for the user 5 to select the facilities and sends the same (S97). The reservation screen information herein produced is received by the reservation screen information receiving portion 443 via the communications interface 441.

The reservation screen information received by the reservation screen information receiving portion 443 is supplied to the display control portion 446, and the display control portion 446 visually displays the same in, as shown in FIG. 11, a form to make a user carry out a selection input by a button display or, as shown in FIG. 12, in addition to a present location, an arrangement of facilities installed at the periphery in a map form, and also displays already-reserved facilities in a manner differentiated from other facilities, thereby making a selecting operation by the user 5 easy.

The user 5, who has browsed reservation screen information through a liquid crystal touch panel of the on-site reservation terminal unit 44, touches a preferred facility for a designation selection. In the case of a reservation screen shown in FIG. 11, a designation selection can be carried out by touching a button, and in the case of a reservation screen shown in FIG. 12, by touching the inside of a balloon line. Selection input information by the user 5 is taken in by the selection input information communicating portion 444 and is sent to the center server 31 via the communications interface 441. Herein, in a screen composition example as shown in FIG. 12, already-reserved facilities and other reserving facilities are displayed in a manner differentiated by color displays (in the drawing, a hatching display), etc. (Area B has been selected in FIG. 12).

The center server 31, which has taken in this selection input information via the communications network 60 (S98), checks the status information of the ID management DB 302, refers to an already-entered flag (E) (S99) to confirm that the admission ticket 10 has already made an admission into the event site 4, whereby, the facility reservation DB updating portion 316 registers information for the selected facility name and time slot with the facility reservation DB 303. Simultaneously, the field of the number of available reservations of the facility reservation DB 303 is updated by +1 (S100).

Herein, the admission monitoring portion 314 reads out, at the time of admission into the event site 4 or an on-site facility, the element ID of the RF-ID tag 100 embedded and mounted in the admission ticket 10 via the site entrance gate 42 or facility admission gate 43, and carries out gate control to permit or prohibit admission while referring to facility reservation information registered with the facility reservation DB 303 with the same ID as a key. This gate control may be carried out at the event site 4 (internal server 41) side or may be carried out by the center server 31 of the reservation center 3. In addition, in either case of advance reservation and same-day reservation, an input or notice of an admission ticket ID and an input or notice, etc., of reserving facility names may be prompted by a voice guide.

As described in the above, according to the present embodiment, by use of an admission ticket 10 provided with an element ID (first identifier) by an information storing element (an RF-ID tag 100) and an admission ticket ID (second identifier) by print (display) as a medium, a facility reserving method and a reserving system which allows a user to easily carry out a reservation and securely carry out a reservation and which also allows a reservation receiver to securely accept a reservation can be provided. In addition, paper admission tickets 10 are handled as electronic admission tickets, and restrictions concerning facility reservation are completely eliminated by carrying out individual ID control of the admission tickets 10, thus a sophisticated facility reserving service can be realized. In addition, since the admission tickets 10 are made of paper, compared to admission tickets made of plastic or the like, load which can be exerted on the environment in disposal can be small. In addition, the IDs may not necessarily be sequential but may be random IDs.

Moreover, by recording programs executed in the communications interface 311, authenticating portion 312, reservation information registering portion 313, admission monitoring portion 314, available time slot searching/outputting portion 315, facility reservation DB updating portion 316, Gr. reservation receiving portion 317, reservation screen information producing/outputting portion 318, communications interface 441, input/output interface 442, reservation screen information receiving portion 443, selection input information communicating portion 444, element ID sending portion 445, and display control portion 446, respectively, as shown in FIG. 3 and FIG. 6 on a computer-readable recording medium, and making these programs recorded on the recording medium be read in a computer system and executing the same, a facility reserving system is realized. The computer system herein referred includes its OS (Operating System) and hardware such as peripheral devices.

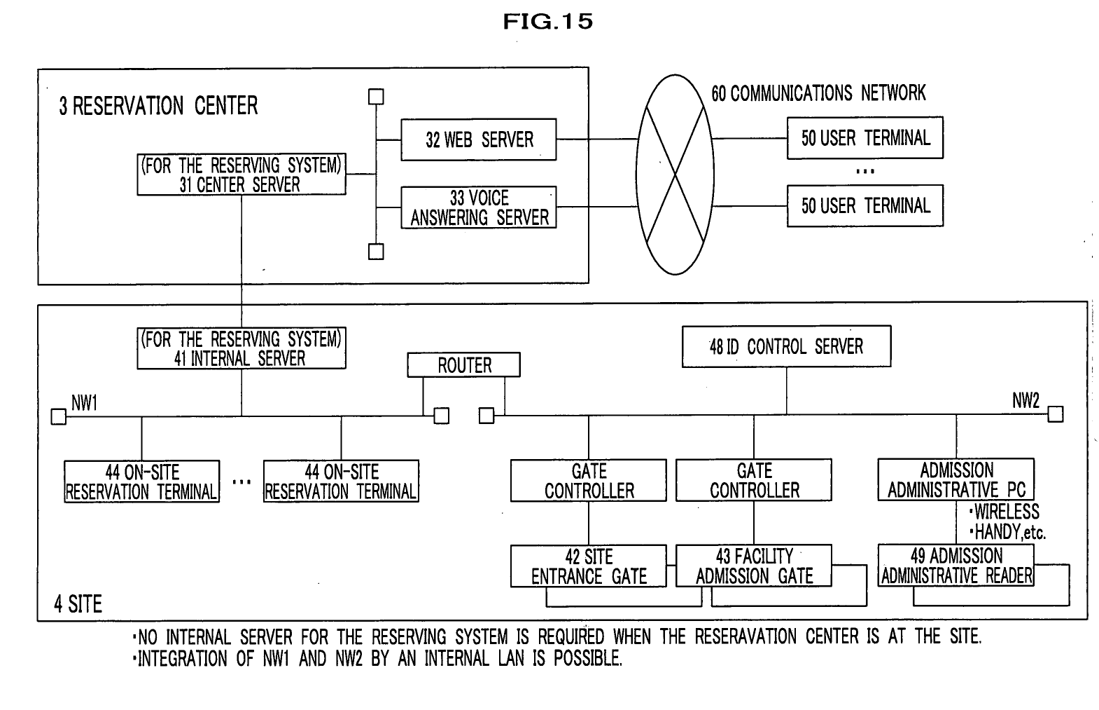

Moreover, FIG. 15 is a reference view showing a connection relationship of servers, etc., and the respective servers and apparatuses can be arranged as in this drawing. In this reference view, internal reservation terminals 44 are LAN-connected to an internal server 41. An ID management server 48 to manage element IDs and admission ticket IDs is connected to the internal server 41 via a router. To the ID management server 48, a site entrance gate 42 and a facility admission gate 43 are LAN-connected via a gate controller. In addition, to the ID management sever 48, an admission administrative reader 49 is, for example, wirelessly connected via an admission administrative PC. If the reservation center 3 is inside the site 4, the internal server 41 can be omitted, for example. In addition, NW1 and NW2 can be integrated by one internal LAN.

What is claimed is:

1. A facility reserving method in which, by use of an admission ticket in which an information storage element having a computer-identifiable unique, first identifier is mounted and on which a human-perceptible unique, second identifier is displayed, a reservation for admission into one or more facilities installed at a site to which admittance is granted with this admission ticket is accepted via a communications network from a user distributed with at least said admission ticket, wherein
a reservation is accepted while comprising the steps of:
carrying out a screen display to a user terminal operated by said user and prompting an input of the second identifier displayed on the admission ticket;
receiving said second identifier inputted by thus prompting and carrying out authentication with the received second identifier;
carrying out a screen display to said user terminal and prompting an input of a name of said reserving facility and a reservation time for reservation; and
receiving said facility name and reservation time inputted by thus prompting and registering the received facility name and reservation time with a facility reservation DB in a manner associated with said first identifier, and
the facility reservation DB thus received registration is used for facility admission administration.

2. A facility reserving method in which, by use of an admission ticket in which an information storage element having a computer-identifiable unique, first identifier is mounted and on which a human-perceptible unique, second identifier is displayed, a reservation for use of one or more facilities installed at a site to which admittance is granted with this admission ticket is accepted via a telephone from a user distributed with at least said admission ticket, wherein
a reservation is accepted while comprising the steps of:
carrying out a voice guide to a telephone used by said user and prompting an input or notice of the second identifier displayed on the admission ticket;
receiving said second identifier inputted or notified by thus prompting and carrying out authentication with the received second identifier;
carrying out a voice guide to said telephone and prompting an input of a name of said facility and a reservation time for reservation; and
receiving said facility name and reservation time inputted or notified by thus prompting and registering the received facility name and reservation time with a facility reservation DB in a manner associated with said first identifier, and
the facility reservation DB thus received registration is used for facility admission administration.

3. A facility reserving system which is connected to a user terminal via a communications network and in which, by use of an admission ticket mounted with an information storage element having a computer-identifiable unique, first identifier, a reservation for admission into one or more facilities installed at a site to which admittance is granted with this admission ticket is carried out, wherein comprising:
an authenticating means for receiving a human-perceptible unique, second identifier displayed on the sold admission ticket via the communications network and thereby authenticating validity thereof; and
a reservation information registering means for carrying out communications with said user terminal upon obtaining the authentication and registering, with a facility reservation DB, said first identifier and information for reserving facility names and reservation time slots thereof produced by a user operating said user terminal in an associated manner.

4. The facility reserving system as set forth in claim 3, wherein
at the time of admission into said site or facility, the unique, first identifier of the information storage element mounted in said admission ticket is readout, and admission is permitted while referring to facility reservation information registered with said facility reservation DB with this identifier as a key.

5. A facility reserving system which is connected to a user terminal via a communications network and in which, by use of an admission ticket mounted with an information storage element having a computer-identifiable unique, first identifier, a reservation for admission into one or more facilities installed at a site to which admittance is granted with this admission ticket is carried out, wherein comprising:
a facility reservation DB in which limits in the number of available reservations of said facility according to admission time slots are preset and numbers of already-reserved visitors at the moment are stored one after another;
an available time slot information searching/outputting means for referring to said facility reservation DB upon receiving a reservation input of a date and time of admission via said user terminal and searching and outputting available time slots of the reserving facility on the day of admission where the current number of already-reserved visitors is smaller than the limit in the number of available reservations; and
a facility reservation DB updating means for registering, with said facility reservation DB, time slot information selected from said available time slots in a manner associated with the first identifier of the information storage element mounted in said admission ticket and for updating the number of already-reserved visitors at the moment.

6. A facility reserving system which is connected to an on-site-installed reservation terminal installed in an arbitrary location of a site via a communications network and in which, by use of an admission ticket mounted with an information storage element having a computer-identifiable unique, first identifier, a reservation for admission into one or more facilities installed at a site to which admittance is granted with this admission ticket is carried out, wherein comprising:
a facility reservation DB in which limits in the number of available reservations of said facility according to admission time slots of the day are preset and numbers of already-reserved visitors at the moment are stored one after another;
an available time slot information searching/outputting means for making said admission ticket be read in said on-site-installed reservation terminal, referring to said facility reservation DB upon receiving a reservation input for a facility for which admission is requested carried out by a user operating said on-site-installed reservation terminal, and searching and outputting available time slots of the applicable facility on the day of admission where the current number of already-reserved visitors is smaller than the limit in the number of available reservations; and
a facility reservation DB updating means for registering, with said facility reservation DB, time slot information selected from said available time slots in a manner associated with the first identifier of the information storage element mounted in said admission ticket and for updating the number of already-reserved visitors on the day at the moment.

7. The facility reserving system as set forth in any one of claims 3, 5, and 6, comprising:
a group reservation receiving means for receiving human-perceptible unique, second identifiers respectively displayed on admission tickets for a predetermined number of persons via an admission ticket possessed by a representative and permitting a reservation input thereof only for an identical time slot of an identical facility.

8. The facility reserving system as set forth in any one of claims 3, 5, and 6, comprising:
a reservation screen information producing/outputting means for, by referring to said facility reservation DB, producing screen information in a form where information for reservation-available facility names and time slots thereof can be selected by a user and providing the same to said user terminal or on-site-installed reservation terminal.

9. An on-site-installed reservation terminal which is connected to the facility reserving system as set forth in any one of claims 3 through 8 via a communications network and is installed in an arbitrary location of a site, wherein comprising:
a reservation screen information receiving means for carrying out communications with said facility reserving system upon approximation or loading of information storage element having a computer-identifiable unique, first identifier, mounted in an admission ticket and receiving, from said facility reserving system, reservation screen information in a form where information for reservation-available facility names and time slots thereof can be selected; and
a selection input information communicating means for taking in a selection input for a facility reservation by a user while displaying said reservation screen information and sending the same to said facility reserving system via said communications network.

10. The on-site-installed reservation terminal as set forth in claim 9, comprising:
a display control means for displaying, in addition to a present location, an arrangement of facilities installed at the periphery in a map form and also displaying already-reserved facilities in a manner differentiated from other facilities.

11. A reservation program for a facility reserving system in which, by use of an admission ticket in which an information storage element having a computer-identifiable unique, first identifier is mounted and on which a human-perceptible unique, second identifier is displayed, a reservation for utilization of one or more facilities installed at a site to which admittance is granted with this admission ticket is accepted via a communications network from a user distributed with at least said admission ticket, wherein
said reservation program makes a computer execute the steps of:
carrying out a screen display to a user terminal operated by said user and prompting an input of the second identifier displayed on the admission ticket;
receiving said second identifier inputted by thus prompting and carrying out authentication with the received second identifier;
carrying out a screen display to said user terminal and prompting an input of a name of said facility and a reservation time for reservation; and
receiving said facility name and reservation time inputted by thus prompting and registering the received facility name and reservation time with a facility reservation DB in a manner associated with said first identifier.

12. A reservation program for a facility reserving system which is connected to a user terminal via a communications network and in which, by use of an admission ticket mounted with an information storage element having a computer-identifiable unique, first identifier, a reservation for admission into one or more facilities installed at a site to which admittance is granted with this admission ticket is carried out, wherein
said reservation program makes a computer execute the steps of:
receiving a reservation input of a date and time of admission via said user terminal, and referring to a facility reservation DB in which limits in the number of available reservations of said facility according to admission time slots are preset and numbers of already-reserved visitors at the moment are stored one after another;
searching and outputting available times lots of there serving facility on the day of admission where the current number of already-reserved visitors is smaller than the limit in the number of available reservations; and
registering, with said facility reservation DB, time slot information selected from said available time slots in a manner associated with the first identifier and updating the number of already-reserved visitors at the moment.

13. A reservation program for a facility reserving facility reserving system which is connected to an on-site-installed reservation terminal installed in an arbitrary location of a site via a communications network and in which, by use of an information storage element having a computer-identifiable unique, first identifier, mounted in an admission ticket, a reservation for admission into one or more facilities installed at a site to which admittance is granted with this admission ticket is carried out, wherein
said reservation program makes a computer execute the steps of:
receiving a reservation input for a facility for which admission is requested carried out by a user operating said on-site-installed reservation terminal in a manner such that the on-site-installed reservation terminal reads in the admission ticket, and referring to a facility reservation DB in which limits in the number of available reservations of said facility according to admission time slots of the day are preset and numbers of already-reserved visitors at the moment are stored one after another;
searching and outputting available time slots of the applicable facility on the day of admission where the current number of already-reserved visitors is smaller than the limit in the number of available reservations; and
registering, with said facility reservation DB, time slot information selected from said available time slots in a manner associated with the unique, first identifier of the information storage element mounted in said admission ticket and updating the number of already-reserved visitors on the day at the moment.
